(19) United States
(12) Patent Application Publication
(10) Pub. No.: US 2003/0101383 A1
(43) Pub. Date: May 29, 2003

(54) Automatic file system maintainer

(76) Inventor: Barry L. Carlson, Issaquah, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 09/997,463

(22) Filed: Nov. 29, 2001

(51) Int. Cl. H04B 1/74

(52) U.S. Cl. 714/42

(57) ABSTRACT

An automatic file maintenance system runs as a background thread, as part of the operating system, alleviating a system or network administrator from having to coordinate file maintenance procedures around the computer system's normal activity. The preferred automatic maintenance system continually assembles various statistics regarding the file system and looks for slow or inactive storage device access periods of time during which files or portions of files can be moved. Such file movements are dictated by the file statistics. Moreover, rather than ceasing normal computer system operation to run file maintenance routines, file maintenance is performed in bits and pieces throughout the day during periods of time in which the storage devices are being otherwise being used.

### CROSS-REFERENCE TO RELATED APPLICATIONS

Not applicable

### STATEMENT REGARDING FEDERALLY SPONSORED RESEARCH OR DEVELOPMENT

Not applicable.

### BACKGROUND OF THE INVENTION

1. Field of the Invention

The present invention generally relates to file system maintenance in a computer system. More particularly, the present invention relates to file maintenance that is performed automatically. Still more particularly, the invention relates to performing file defragmentation and file and disk balancing operations in the background while other applications are running.

2. Background of the Invention

As is well known, a computer system includes one or more microprocessors, bridge devices, memory, mass storage (e.g., a hard disk drive), and other hardware components interconnected via a series of busses. In general, the overall operating speed of the computer is a function of the speed of its various components. Today, microprocessors operate much faster than disk drives. Thus, often a limiting factor for a computer's overall speed is the input/output (“I/O”) cycle speed of the mass storage system. The speed of I/O cycles can be increased either by designing faster mass storage or by interacting with the mass storage in a more efficient manner. The present invention results from the latter approach (more efficient disk drive interaction).

As files (e.g., spreadsheets, text files, etc.) are stored on and deleted from a storage device, it is common for there to be numerous blocks of “free space” (i.e., unused storage locations) interspersed between used space. Further, the computer's file subsystem may store a file on a storage device by breaking apart the single file into multiple smaller units and storing those smaller units in the various free spaces of the drive. This process is called “fragmentation.” It takes more time to access a file that has been split apart in this fashion than if the file were kept together in a single contiguous area on the storage device. For this reason, many computers include an application maintenance tool that can be run by the user to “defragment” one or more files. Defragmentation refers to the process of moving the various non-contiguous units of a file into a single contiguous space on the storage device. File defragmentation generally increases the performance of the file subsystem because fewer I/O cycles are needed to access the file.

Another way to improve the performance of a file subsystem is to evenly distribute file I/O over mass storage devices. For example, certain files may generate more I/O cycles than other files. In a computer system having multiple storage devices, the files without more I/O cycles (referred to as “hot files”) can be stored on different storage devices which generally can be accessed simultaneously by the file subsystem. Accordingly, rather than slowing down one storage device with all the file I/O, the hottest files can be more quickly accessed by placing them on different, but concurrently accessible disks. To this end, an application tool can be run on a computer to determine which files are the hottest files and to move the files to various disks as is deemed appropriate.

Further still, an application tool can be run to move files between the various disks in an attempt to make the amount of free space roughly the same on each of the disks. Balancing the amount of free space across the disks also helps to reduce the amount of I/Os and to increase the performance of the file subsystem.

These various file maintenance tasks typically are performed as noted above by application tools that are run at the request of a user (or scheduled to run at certain times by a user). These maintenance tools reduce the performance of the system while they run. For that reason, network administrators typically schedule the file maintenance routines to run after normal business hours or on weekends when system usage is lower. This is generally satisfactory, but is becoming increasingly less satisfactory for organizations that operate 24 hours per day, seven days per week. There may be no time of lower computer system usage for these so called “24/7” organizations. Accordingly, system administrators are forced to do one of two things. On one hand, the maintenance routines can be run and the organization will simply have to live with diminished system performance while the file maintenance is being run. Alternatively, the system administrator can forego the file maintenance to keep the organization's computer network operating, but live with the degradation in performance that will occur over time.

Clearly, a solution to the aforementioned problem is needed. Such a solution preferably would be able to perform the needed file system maintenance, but in a way that does not interfere with normal system operation.

### BRIEF SUMMARY OF THE INVENTION

The problems noted above are solved by an automatic file maintenance system runs as a background thread alleviating a computer network administrator from having to coordinate file maintenance procedures around the computer system's normal activity. The preferred automatic maintenance system continually assembles various statistics regarding the file system and looks for slow or inactive storage device access periods of time during which files or portions of files can be moved. Such file movements are dictated by the file statistics. Moreover, rather than ceasing normal computer system operation to run file maintenance routines, file maintenance is performed in bits and pieces throughout the day during transient periods of time in which the storage devices are otherwise not being used.

### BRIEF DESCRIPTION OF THE DRAWINGS

For a detailed description of the preferred embodiments of the invention, reference will now be made to the accompanying drawings in which:

FIG. 1 is a system diagram of the preferred embodiment of the invention in which file maintenance is performed automatically in concert with normal system operation;

FIG. 2 depicts a file that has been fragmented into multiple extents;

FIG. 3 conceptually illustrates file defragmentation into single extent;

FIG. 4 illustrates a file being defragmented into multiple, but fewer, extents;

FIG. 5 illustrates a preferred algorithm for determining on which disk to move a hot file; and

FIG. 6 illustrates a preferred method for moving defragmented files to balance the amount of free space on the various disks.

### NOTATION AND NOMENCLATURE

Certain terms are used throughout the following description and claims to refer to particular system components. As one skilled in the art will appreciate, computer companies may refer to a given component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct electrical connection. Thus, if a first device “couples” to a second device, that connection may be through a direct electrical connection, or through an indirect electrical connection via other devices and connections. Further, the term “extent” refers to a collection of one or more contiguous disk blocks in which a file or part of a file is stored. A single file may require multiple extents for its storage on a disk.

To the extent that any term is not specially defined in this specification, the intent is that the term is to be given its plain and ordinary meaning.

### DETAILED DESCRIPTION OF THE PREFERRED EMBODIMENTS

The problem noted above is generally solved by performing file maintenance procedures in the background while other applications may be running in the system. More specifically, the preferred technique is to continuously analyze the behavior of the file subsystem, detect periods of little or no file activity (which may be transient in nature) and perform bits and pieces of the file maintenance activity in such low activity periods, time permitting. As such, the system continuously attempts to improve the performance of the file subsystem through continual, albeit sporadic, file maintenance. The following description discloses one suitable embodiment of the foregoing methodology.

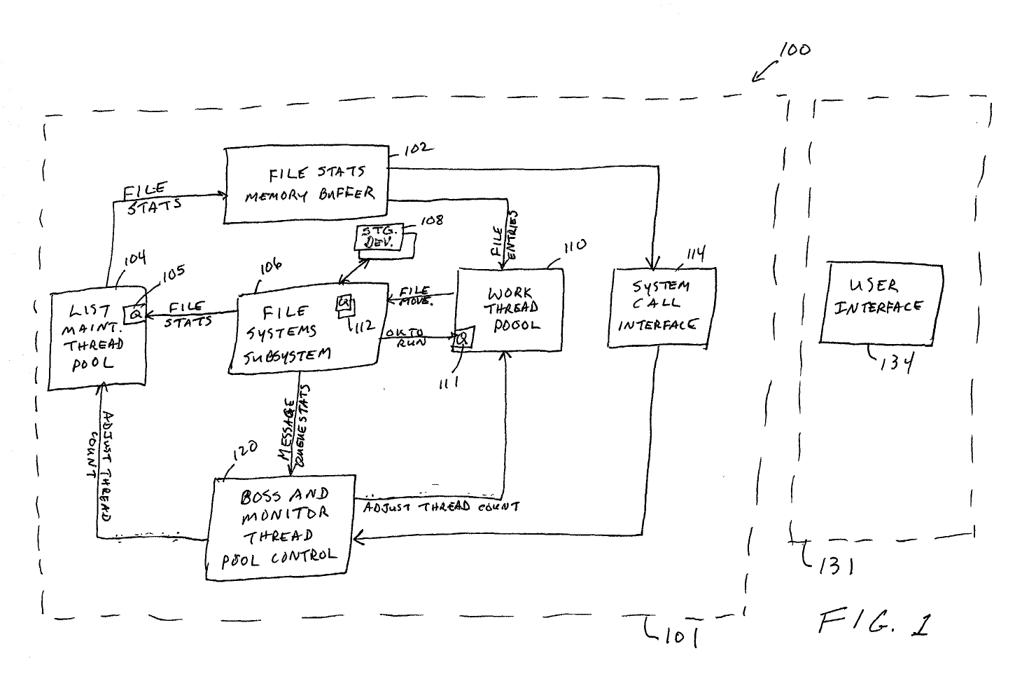

Referring now to FIG. 1, a software architecture 100 for an electronic system constructed in accordance with the preferred embodiment of the invention includes a file statistics (stats) memory buffer 102, a list maintenance thread pool 104, a file system subsystem 106, a work thread pool 110, a system call interface 114, and a boss and monitor thread pool control 120, all preferably included within an operating system kernel 101. The file system subsystem 106 is able to read from and write to one or more storage devices 108.

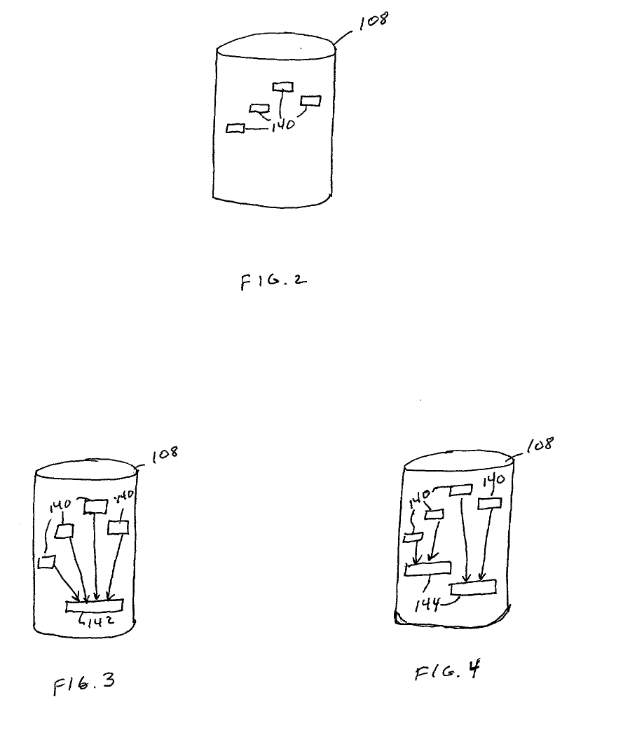

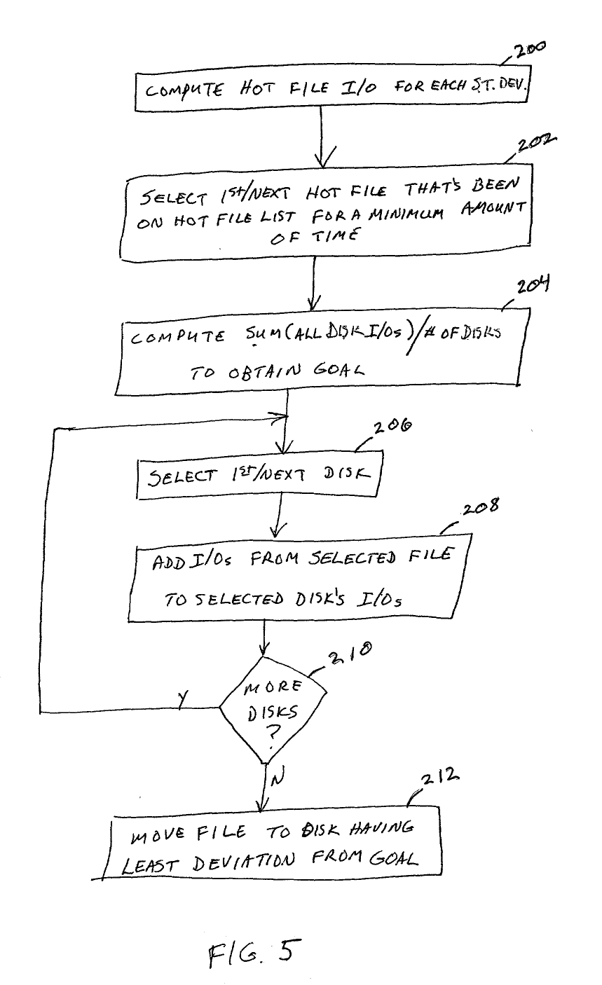

The system 100 preferably performs three basic activities in the background—real-time file analysis, detection of low activity disk I/O periods of time, and movement of files or parts of files during such low activity periods. These three activities occur during normal system operation in a background mode. The real-time analysis, preferably performed by the file system subsystem 106 and list maintenance thread pool 104, generally creates and/or updates two lists which are stored in the file stats buffer 102. One list is a fragmentation list. This list includes an entry for each file stored on the disks 108 that has been fragmented and thus for which defragmentation would be appropriate. Files that have not been fragmented may or may not be included in this list. Each entry includes a value that is representative of the ratio of the size of the file to the number of “extents” used to store the file on the storage device. An extent is a collection of one or more contiguous disk blocks, where a block represents a predetermined number of bytes. For example, referring briefly to FIG. 2, one file is stored on a storage device 108 in four extents 140. The more extents that are used to store a given file, relative to the size of the file, the less efficient the system will be in accessing that file. Accordingly, the information in the fragmentation list is used to determine which files stand the most to gain by defragmentation. Defragmenting the file of FIG. 2 may mean defragmenting the four extents 140 into a single extent 142 as in FIG. 3 or two extents 144 as in FIG. 4. In general, defragmentation simply refers to reducing the number of extents used to store a file.

The second list being updated in real-time includes an entry for each file that specifies how many I/O cycles have occurred for that file. The so-called “hot files” are the files that are requesting an I/O more often than other files over a given time period. The time period for measuring this characteristic may be programmable and may be any time period (e.g., a day or a week). Thus, the hot file list specifies the frequency of I/O for each file over a given time period.

Referring again to FIG. 1, the file system subsystem 106 generates the raw data used to generate the above fragmentation and hot lists, provides that information to the list maintenance thread pool 104 over the message line labeled “file stats” and the list maintenance thread pool 104 updates the lists stored in the file stats memory buffer 102. The file stats information is provided to a message queue 105 included as part of the list maintenance thread pool 104. The list maintenance thread pool 104 retrieves the file stats messages from queue 105 for further processing as noted above.

In addition to real-time analysis of the file system, the second basic activity performed by system 100 is to determine when file maintenance can occur. This function preferably is performed by the file system subsystem 106. The file system subsystem includes an I/O queue 112 into which storage device I/Os accesses are stored pending use by the file system subsystem. There may be one queue 112 for each storage device 108. When a storage device I/O from the queue 112 has been performed, and the operating system is notified of such, the file system subsystem determines whether more storage device I/O requests are pending in queue 112. If the I/O queue is empty, meaning that the storage device 108 would be idle anyway, then the file system subsystem determines that file maintenance can occur. In this case, the file system subsystem 106 sends an “OK to Run” message to the work thread pool 110. More particularly, the OK to Run messages are stored in a queue 111 in the work thread pool 110. The work thread pool 110 then retrieves the messages for further processing from queue 111.

The work thread pool 110 preferably includes at least one thread for each storage device in the mass storage array 108. The purpose of each thread is to move files or file segments around on the disks to reduce the number of needed I/Os to thereby increase the overall performance of the file system. The threads execute code that performs several different kinds of file maintenance. For example, the work threads may perform file defragmentation, such as that shown in FIGS. 3 and 4. In general, a file is defragmented by reducing the number of extents necessary to store the file. The work threads in pool 110 receive file entries from the file stats buffer 102 to determine which files to defragment. In accordance with the preferred embodiment, the file that is defragmented next is the file that has the lowest ratio of file size to number of extents, although other selection criteria can be used. The instruction as to which file to defragment is provided to the file system subsystem 106 which then performs the actual file movement sequences necessary to accomplish the desired fragmentation. Thus, during the low activity periods the work thread pool 110 determines the file that could benefit most from being defragmented and then causes that file to be defragmented.

Another type of file maintenance that the work thread pool 110 performs is to better distribute I/O across the storage devices 108. For example, I/O distribution is improved by ensuring that the hottest files are stored on separate storage devices. As such, if the mass storage array 108 includes five storage devices, the work thread pool 110 may take the five hottest files listed in the file stats memory buffer 102 and move the files around to place them on five separate storage devices. The instructions are conveyed to the file system subsystem 106 as to how to move the files to I/O balance the file system.

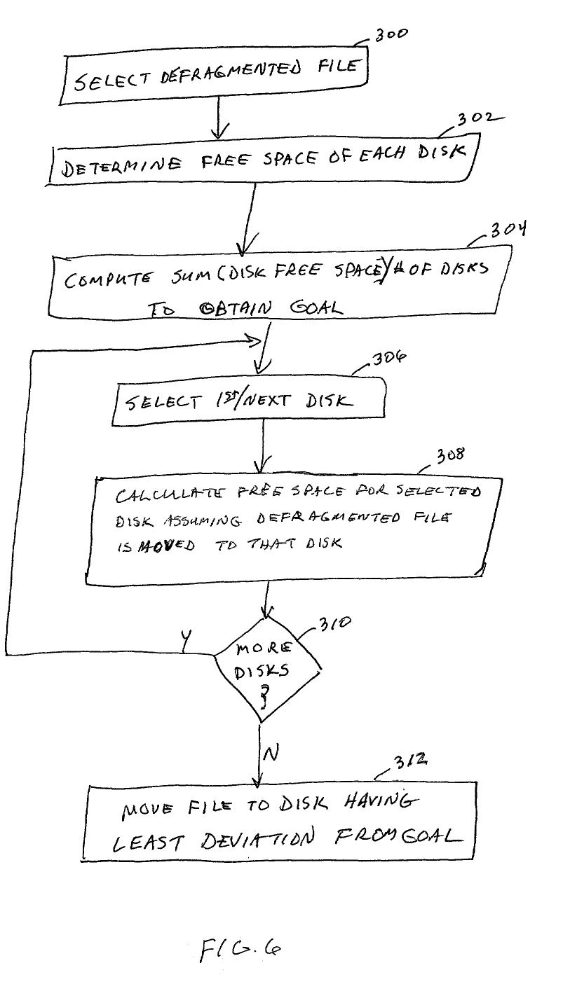

FIG. 5 illustrates one suitable technique for moving hot files around to improve performance. In step 200 the number of I/O accesses for the hot files on each storage device is obtained from the file stats memory buffer 102. The hot files in this context are the hottest files in a predetermined threshold. Then, in 202 the first or next hot file that has been on the hot file list for at least a predetermined minimum amount of time is selected. Steps 204-212 are performed to determine to where to move that hot file to increase system performance. In step 204, the average of the hot file I/Os for all of the storage devices is computed (referred to as the “goal”). The goal is computed by summing together the number of hot file I/Os for each disk (determined in 200) and then dividing by the number of storage devices in the array 108 (FIG. 1).

A loop is then begun comprising steps 206, 208, and 210. In step 206 a disk is selected. Then, in 208, the number of I/Os pertaining to the file selected in 202 (accumulated over a specified period of time) is added to the total number of I/Os for the disk selected in 206. If there are additional disks, then control loops back to step 206. The process of steps 206 and 208 is repeated until the number of I/Os for the selected file has been added to the total number of I/Os for each of the disks. Then, in step 212, the selected hot file is moved to the disk that, when the file's I/Os were added to the disk's I/Os, resulted in the least deviation from the goal computed in 204.

Another way to balance the storage devices 108 is to move files around to maintain a similar amount of free disk space on each disk. The amount of free space for each storage device preferably is obtained from the storage devices 108 and thus is used by the work thread pool 110 to determine if files from one disk should be moved to another disk to better balance the disks. When balancing the disks, the work threads 110 balance, not only single files against other single files, but also single files against smaller multiple files. For example, it may be more efficient to move two 500 K byte files to another disk instead of one 1 M byte file because the larger file may be one of the hottest files and should remain where it is because other hot files are already on the other disks.

Further, if desired, a file that has been defragmented may be moved during the defragmentation process to a different drive to better balance the disks. FIG. 6 illustrates an exemplary algorithm for moving a defragmented file to a disk to better balance the disks in terms of free space. In step 300 a file that has been defragmented is selected. Then, in 302 the amount of free space for each disk is determined. Steps 304-312 are performed to determine to where to move the defragmented file to better balance the amount of free space on the storage devices 108. In step 304, the average amount of free space for the disks is computed (referred to as the “goal”). The goal is computed by summing together the amount of free space for each disk (determined in 302) and then dividing by the number of disks in the array 108.

A loop is then begun comprising steps 306, 308, and 310. In step 306 a disk is selected. Then, in 308, the size of the defragmented file selected in 300 is subtracted from the free space for the disk selected in 306 to calculate the amount of free space on the disk that would result if the file were moved to that disk. If there are additional disks, then control loops back to step 306. The process of steps 306 and 308 is repeated until the free space for each disk has been calculated assuming the defragmented file was added to each disk. Then, in step 312, the selected defragmented file is moved to the disk that results in the least deviation from the goal computed in 304.

Movement of a file or portion of a file can be accomplished in a variety of ways. One such way is to copy the file or file portion to the computer's main system memory (not specifically shown) and then write that file/portion to a new location on disk. The original location can then be released as free space for use by other files.

Referring still to FIG. 1, the boss and monitor thread pool control 120 determines whether more threads should be spawned in the list maintenance thread pool 104 and the work thread pool 110 to increase the productivity of the disk maintenance infrastructure. In general, the boss and monitor thread pool control 120 monitors the status of queues 105 and 111, provided via the message queue stats line from the file system subsystem 106, and adjusts (i.e., increases or decreases) the number of threads in pools 104 and 110 in accordance with the backlog (or lack thereof) of messages in the queues 105, 111. For example, if the queue 111 is full or nearly fall, the boss and monitor thread pool control 120 may increase the number of work threads in pool 110 to handle the heavier transaction demand on pool 110.

System 100 also provides a mechanism for users to interact with and program the automatic file maintenance system 101. Accordingly, in a user space 131, an interface module 134 is provided which interacts with the file maintenance system 101 via a system call interface module 114. Through the user interface 134, a user can perform various control operations. For example, a user can enable and disable the entire automatic file maintenance system. Further, a user can enable/disable one feature of the file maintenance system such as file defragmentation and hot file storage device balancing. Further still, a user can adjust the operation of the automatic file system 101 by setting various parameters associated with the system. By way of example of such user customization, a user can specify how often automatic file maintenance will be permitted to occur, the maximum number of threads the boss and monitor thread pool control 120 is capable of spawning in pools 104, 110, how many hot files are processed during a hot file movement process, etc.

The preferred embodiment described above provides an automatic file maintenance system that runs as a background process alleviating a system or network administrator from having to coordinate file maintenance procedures around the computer system's normal activity. The preferred automatic maintenance system continually assembles various statistics regarding the file system and looks for slow or inactive storage device access periods of time during which files or portions of files can be moved. Such file movements are dictated by the file statistics. Moreover, rather than ceasing normal computer system operation to run file maintenance routines, file maintenance is performed in bits and pieces throughout the day during periods of time in which the disks are being otherwise being used.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method of performing file maintenance on a plurality of storage devices, comprising:
(a) measuring file system parameters;
(b) determining periods of low disk activity; and
(c) upon determination of low disk activity period, performing a file maintenance action based on said system parameters;
wherein (a), (b), and (c) are performed automatically.

2. The method of claim 1 wherein (a) includes maintaining a list of the files with the most I/O.

3. The method of claim 2 wherein (c) includes computing the average number of I/O cycles on the storage devices and moving a file from one disk to another based on said average.

4. The method of claim 3 wherein said file is moved to the disk that results in the smallest deviation from the average.

5. The method of claim 1 wherein (a) includes maintaining a list of the files with the most I/O over a programmable period of time.

6. The method of claim 1 wherein (a) includes maintaining a fragmentation list of files that have been fragmented.

7. The method of claim 6 wherein for each fragmented file in the fragmentation list, a value is stored, said value being representative of the ratio of the size of the fragmented file to the number of extents that are necessary to store the file on the storage devices.

8. The method of claim 7 wherein (c) includes selecting for defragmentation a fragmented file that has a lower ratio than other fragmented files.

9. The method of claim 6 wherein (c) includes selecting a fragmented file to be defragmented and storing said defragmented file on a different storage device than was used to store said fragmented file.

10. The method of claim 6 wherein (c) includes selecting a fragmented file to be defragmented and storing said defragmented file on the same storage device than was used to store said fragmented file.

11. The method of claim 9 wherein (c) includes determining on which storage device to store said defragmented file, said storage device determination including:
(c1) determining the amount of free space on each of said storage devices;
(c2) computing the average amount of free space on said storage devices; and
(c3) selecting the storage device on which to store said defragmented file that would result in an amount of free space that is closer to the average computed in (c2) than would be the case with other of said storage devices.

12. The method of claim 1 wherein (b) includes examining a queue of pending storage device I/O requests to determine whether any I/O requests are pending.

13. A computer system, comprising:
a processor;
random access memory coupled to said processor;
a plurality of storage devices coupled to said processor;
software stored on said random access memory and executed by said processor, said
software performing maintenance on files stored on said storage devices in a background mode.

14. The computer system of claim 13 wherein said software maintains a list of the files with the most I/O in said random access memory.

15. The computer system of claim 14 wherein said software computes the average number of I/O cycles for a predetermined set of files with the most I/O on the storage devices and moving a file from one storage device to another based on said average.

16. The computer system of claim 15 wherein said software causes said file to be moved to the disk that results in the smallest deviation from the average.

17. The computer system of claim 13 wherein said software maintains a list of the files with the most I/O over a programmable period of time.

18. The computer system of claim 13 wherein said software maintains a fragmentation list of files that have been fragmented.

19. The computer system of claim 18 wherein for each fragmented file in the fragmentation list, said software stores a value, said value being representative of the ratio of the size of the fragmented file to the number of extents that are necessary to store the file on the storage devices.

20. The computer system of claim 19 wherein said software selects for defragmentation a fragmented file that has a lower ratio than other fragmented files.

21. The computer system of claim 18 wherein said software selects a fragmented file to be defragmented and stores said defragmented file on a different storage device than was used to store said fragmented file.

22. The computer system of claim 18 wherein said software selects a fragmented file to be defragmented and stores said defragmented file on the same storage device than was used to store said fragmented file.

23. The computer system of claim 21 wherein said software determines on which storage device to store said defragmented file by:
determining the amount of free space on each of said storage devices;
computing the average amount of free space on said storage devices; and
selecting the storage device on which to store said defragmented file that would result in an amount of free space that is closer to the average than would be the case with other of said storage devices.

24. The computer system of claim 13 wherein said software examines a queue of pending storage device I/O requests to determine whether any I/O requests are pending.
